(19) United States
(12) Patent Application Publication
(10) Pub. No.: US 2025/0211531 A1
(43) Pub. Date: Jun. 26, 2025

(54) METHOD AND DEVICE FOR UPDATING A TIME AT WHICH AT LEAST ONE DATA PACKET IS TAKEN FROM AN AUDIOVISUAL STREAM

(71) Applicant: AVIWEST, Saint-Gregoire (FR)

(72) Inventors: Yannick OMNES, Saint-Gregoire (FR); Clément GEROUVILLE, Saint-Gregoire (FR); Ronan POULLAOUEC, Saint-Gregoire (FR)

(73) Assignee: AVIWEST, Saint-Gregoire (FR)

(21) Appl. No.: 18/986,515

(22) Filed: Dec. 18, 2024

(30) Foreign Application Priority Data
Dec. 22, 2023 (FR) 2315118

(51) Int. Cl. H04L 47/11; H04L 43/087; H04L 47/2416; H04L 47/283

(52) U.S. Cl. CPC H04L 47/11; H04L 43/087; H04L 47/2416; H04L 47/283

(57) ABSTRACT

A method and a device for updating a time at which at least one data packet is taken from an audiovisual stream transferred from a transmitter to a receiver by means of at least one communication network. According to the invention, the transmitter transfers a first data packet and receives a second data packet which includes time markers, calculates, from the time markers, a mean transit time, a weighted mean value and a deviation, checks whether the mean transit time is above a predetermined threshold, takes into account the mean transit time to update the time at which at least one data packet is taken from the audiovisual stream if at least the mean transit time is below or equal to the predetermined threshold.

### TECHNICAL FIELD

The present invention relates to a method and a device for updating a time at which at least one data packet is taken from an audiovisual stream.

### PRIOR ART

The transmission of video data packets is subject to time constraints so as to allow good reproduction of the video at the receiver.

These time constraints are subject to the performances of the communication network connecting the transmitter of the video stream and the receiver.

Example, the variations in the transfer latency of the video stream and the desynchronisation of the clocks of the transmitter and of the receiver have an influence on the quality of reproduction of the video stream. Jitter represents the difference in arrival time, between various packets that departed at the same time. Jitter appears in the case of congestion on the network, drift in the timing or change in routing.

Jitter is highly variable over time and is greatly dependent on the type of communication network used for transferring data packets from the transmitter to the receiver.

This is particularly difficult to compensate for when a plurality of communication networks are used simultaneously for transmitting the video stream.

Reproduction of the video at the receiver corresponds to a reproduction at the receiver of the video at the same rhythm as at the transmitter. This makes it possible to avoid jumps related to a phase difference and also to respect the latency without an end-to-end time drift. In conventional systems, the phase between the transmitter and the receiver is respected but not the latency.

The invention aims to propose a solution that makes it possible to take into account the variations in characteristics of the communication network or networks used for transmitting the video stream as well as the desynchronisation of the clocks of the transmitter and of the receiver.

### DISCLOSURE OF THE INVENTION

For this purpose, the invention relates to a method for updating a time for at least one data packet to be taken from an audiovisual stream transferred from a transmitter to a receiver by means of at least one communication network, characterised in that the method comprises the steps performed by the transmitter of:
transferring a first data packet comprising a first time marker corresponding to the instant of sending the first packet,
receiving a second data packet comprising the first time marker, a second time marker corresponding to the time of reception of the first packet and a third time marker corresponding to the instant of sending the second packet,
storing the time of reception of the second packet,
calculating, from the three time markers and from the time of reception of the second packet, a mean transit time,
calculating a weighted mean value and a deviation between the current transit time and the mean transit time,
checking whether the mean transit time is above a predetermined threshold, the predetermined threshold being dependent on the weighted mean value and on the deviation between the current transit time and the mean transit time.
taking into account the mean transit time to update the time at which at least one data packet is taken from the audiovisual stream if at least the mean transit time is below or equal to the predetermined threshold,
not taking into account the mean transit time to update the time at which at least one data packet is taken from the audiovisual stream if the mean transit time is above the predetermined threshold.

The invention also relates to a device for updating a time at which at least one data packet is taken from an audiovisual stream transferred from a transmitter to a receiver by means of at least one communication network, characterised in that the device is included in the transmitter and comprises:
means for transferring a first data packet comprising a first time marker corresponding to the instant of sending the first packet,
means for receiving a second data packet comprising the first time marker, a second time marker corresponding to the time of reception of the first packet and a third time marker corresponding to the instant of sending the second packet,
means for storing the time of reception of the second packet,
means for calculating, from the three time markers and from the time of reception of the second packet, a mean transit time,
means for calculating a weighted mean value and a deviation between the current transit time and the mean transit time,
means for checking whether the mean transit time is above a predetermined threshold, the predetermined threshold being dependent on the weighted mean value and on the deviation between the current transit time and the mean transit time,
means for taking into account the mean transit time to update the time at which at least one data packet is taken from the audiovisual stream if at least the mean transit time is below or equal to the predetermined threshold,
means for not taking into account the mean transit time to update the time at which at least one data packet is taken from the audiovisual stream if the mean transit time is above the predetermined threshold.

Thus the present invention provides a solution that makes it possible to take into account the variations in characteristics of the communication network or networks used for transmitting the video stream as well as the desynchronisation of the clocks of the transmitter and of the receiver. The filtering implemented makes the system resistant to the increase in the transmission times related to a network congestion.

According to a particular embodiment, the taking into account of the mean transit time to update the time at which at least one data packet is taken from the audiovisual stream is furthermore dependent on a comparison of the deviation between the current transit time and the mean transit time with a minimum time.

Thus the increases in latencies caused by a change in network condition rather than by congestion are taken into account and do not cause a blockage of the system.

According to a particular embodiment, the data packets of the audiovisual stream are transferred from the transmitter to the receiver by means of a plurality of communication networks and the method is implemented for each communication network.

Thus the use of a plurality of network interfaces simultaneously allows a precise measurement, for example of the order of one millisecond, of the difference between the clocks of the transmitter and of the receiver without having recourse to a reference point such as for example an NTP (the acronym of the English term Network Time Protocol) server.

According to a particular embodiment, if the mean transit time is above the predetermined threshold, the time at which the at least one packet is taken is updated from the mean transit time of another communication network.

Thus the present invention makes it possible to dispense with errors related to a problem with one of the communication networks.

According to a particular embodiment, the communication networks are networks of the Ethernet, Wi-Fi, xDSL, KA-SAT, BGAN or cellular type.

According to a particular embodiment, the weighted mean value and the deviation between the current transit time and the mean transit time are calculated from the following formulae:
rtt_{curr}=(eᵣ−eₑ) where eₑ is the first time marker and eᵣ is the time of reception of the second packet,

$${rtt}_{meancurr} = \frac{( {α}_{quo} - {α}_{s} ) * {rtt}_{meanprec} + {α}_{s} * {rtt}_{curr}}{{α}_{quo}}$$

$${rtt}_{dev} = \frac{( {α}_{quo} - {α}_{d} ) {rtt}_{dev} + {α}_{d} * ( {rtt}_{curr} - {rtt}_{meancurr} )}{{α}_{quo}}$$

where α_{quo}, αₛ and α_{d} are three coefficients for weighting the values used, rtt_{meancurr} is the mean calculated at the present instant, the variable rtt_{meanprec} is the mean calculated at the previous iteration and rtt_{curr} corresponds to the current value of the transit time.

### BRIEF DESCRIPTION OF THE DRAWINGS

The features of the invention mentioned above, as well as others, will emerge more clearly from the reading of the following description of an example embodiment, said description being made in relation to the accompanying drawings, among which:

FIG. 1 illustrates schematically an example of a communication system wherein the present invention is implemented;

FIG. 2 illustrates schematically an example of distribution of video data packets between various communication networks connecting a transmitter and a receiver;

FIG. 3 illustrates an example of a timing diagram for sending keepalive packets according to the present invention;

FIG. 4 illustrates an example of architecture of a transmitter according to one embodiment;

FIG. 5 illustrates an example of a method implemented by a transmitter according to one embodiment.

### DETAILED DISCLOSURE OF EMBODIMENTS

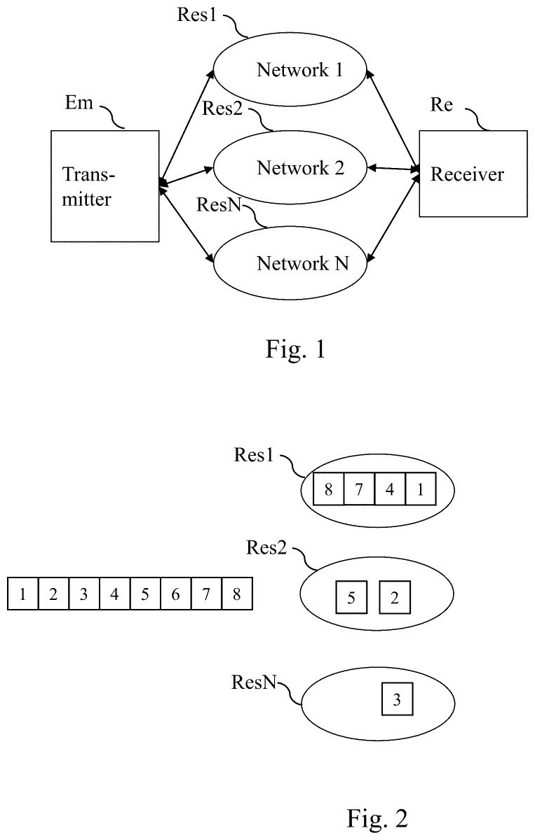

FIG. 1 illustrates schematically an example of a communication system wherein the present invention is implemented.

The communication system comprises a transmitter Em and a receiver Re connected together by at least one communication network Res1. In the example in FIG. 1, the transmitter Em and the receiver Re are connected by a plurality of communication networks Res1, Res2 to ResN.

The communication networks Res1, Res2 to ResN are for example networks of the Ethernet, Wi-Fi, xDSL (from the English Digital Subscriber Line) KA-SAT, BGAN or cellular type.

The data transmitted between the transmitter Em and the receiver Re are data packets of a video stream.

The transmission of video data packets is subject to time constraints so as to allow good reproduction of the video at the receiver.

Conventionally, the time constraint is managed at the transmitter by a time window. The time window corresponds to the time that has to elapse between the entry and exit of a packet in the system. This constraint is important for several reasons. The main one is the compensation for jitter on the network.

Jitter designates the variation in the latency or the variation in the information transfer time. In concrete terms, jitter represents the difference in arrival time, between various packets that departed at the same time. Jitter appears in the case of congestion on the network, drift in the timing or change in routing.

Jitter is highly variable over time and is greatly dependent on the type of communication network used for transferring data packets from the transmitter to the receiver.

When a video encoder generates data packets, it does so at a precise rhythm corresponding to the number of images per second of the video. It is important to be able to ensure that the packets exit from the system at the same rhythm that they entered it. The network however introduces jitter, varying the interval between the packets. Strict compliance with the time window makes it possible to dispense with jitter, which is made all the more important by the use of various networks.

FIG. 2 illustrates schematically an example of distribution of video data packets between various communication networks connecting a transmitter and a receiver.

The data packets transferred are distributed over the various communication networks Res1 to ResN. Each time period corresponds to a configurable time slot, for example 1 ms. The transmitter Em permanently keeps a reference to the time slot corresponding to the current time, called now. The data packets are therefore stored in the time slot corresponding to now+the value of the time window. This is because this time slot corresponds to the moment as from which the packet is considered to be late and must therefore no longer be transmitted. A sequence number is attributed to each packet when they enter the transmission system. A time marking is also affixed to each packet in order to be able to determine the time that it spends in the transmission system.

The transmitter Em has a table of links, each link represents the throughput of one of the communication networks. At each time slot, the transmitter Em runs through the table of links. For each link, the transmitter Em determines the quantity packets to be sent, according to the call frequency and the capacity of the communication network.

The data packets to be sent are retrieved in chronological order following the priority principle in accordance with the deadline of the latter, the tasks the deadline of which is close receiving the highest priority. The data packets are recovered first in the time slots the expiry of which is the closest. When a time slot is emptied, the following one is passed to until the capacity of the communication network is exhausted. The data packets are distributed in alternation on each communication network as long as the throughput of the communication network so permits.

In the example in FIG. 2, the data packet 1 is transmitted over the communication network Res1, the data packet 2 is transmitted over the communication network Res2, the data packet 3 is transmitted over the communication network ResN, the data packet 4 is transmitted over the communication network Res1, the data packet 5 is transmitted over the communication network Res2, the data packet 6 is transmitted over the communication network ResN, and, as the whole of the bandwidth of the communication networks Res2 and ResN has been reached, the data packets 7 and 8 are transmitted over the communication network Res1.

Only the data packets having a chance of being received by the receiver Re in time are transmitted. This makes it possible to avoid a “snowball” effect, causing collapse of the system if the quantity data packets to be transmitted is greater than the capacity of the communication networks available. Having available the capacity of each communication network, the transmitter Em can determine the quantity of audio/video data that it can cause to transit at each instant. This value is made available to the system supplying the video so that it can adapt the video rate to the network constraints of an instant T.

Since the data packets passing over the first communication networks have different latencies, they do not arrive in the correct order. An algorithm must be established in order to overcome this problem. This algorithm must also be responsible for delivering the data packets in compliance with the time constraints. Based on the sequence number affixed to each data packet by the transmitter, the receiver stores the packets in a table. With each packet there is associated an exit time tₛ, obtained by means of the following formula:

$${t}_{s} = {t}_{e} + timewindow - clockdiff$$

tₑ corresponds to the time when the packet enters the transmitter Em and tₛ corresponds to the time when the packet emerges in the receiver Re. At regular intervals, the receiver Re runs through the packets present in the table, and compares their theoretical exit time with the actual time. When the two correspond, the data packet is transmitted.

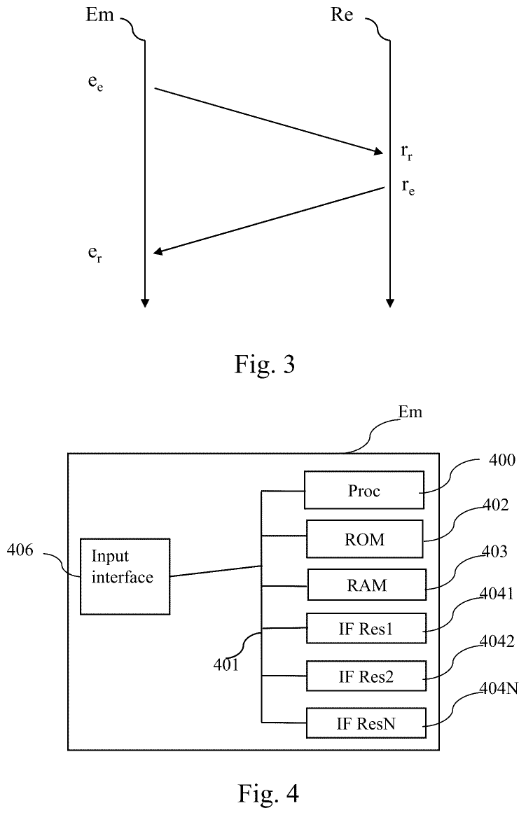

FIG. 3 illustrates an example of a timing diagram for sending keepalive packets according to the present invention.

In order to overcome the clock differences between the transmitter and the receiver, a synchronisation mechanism is established according to the present invention. This makes it possible to determine the difference between the two clocks in real time, in order to enable packets to exit in compliance with the time window.

This mechanism is based on the transmission of data packets called keepalive packets. These have, according to the present invention, a dual function. The first function is to ensure that the communication network is always operational by regularly sending data packets. The second function is the transmission of time markers enabling the clock difference between the transmitter and the receiver, here called clockdiff, to be calculated.

The packets contain time markers.

A first keepalive packet is sent by the transmitter to the receiver. This contains a time marker denoted here eₑ and which corresponds to the instant of sending of said packet. This keepalive packet is next received by the receiver, which notes the reception time (rᵣ). The receiver next responds with a keepalive packet, in which it sets out the two time markers eₑ et rᵣ while adding thereto the time marker of the keepalive packet denoted re.

The transmitter receives the keepalive packet, and stores the time of arrival thereof (eᵣ). It thus has available 4 values, making it possible to establish the following calculations:

$${e}_{mean} = ( {e}_{r} - {e}_{e} ) / 2$$

$${r}_{mean} = ( {r}_{r} - {r}_{e} ) / 2$$

$$clockdiff = {e}_{mean} - {r}_{mean}$$

The values eₘₑₐₙ and rₘₑₐₙ correspond to the time of one half of the transmission.

Conventionally, on an unsaturated network, a packet takes as much time to travel over the uplink as the downlink, these times being in theory identical. Any difference can be attributed to a clock difference between the transmitter and the receiver. It may however happen that the networks do not behave symmetrically. This calculation is, according to the present invention, subject to statistical calculations in order to filter the aberrant time-marker values.

$${rtt}_{curr} = ( {e}_{r} - {e}_{e} )$$

$${rtt}_{meancurr} = \frac{( {α}_{quo} - {α}_{s} ) * {rtt}_{meanprec} + {α}_{s} * {rtt}_{curr}}{{α}_{q u o}}$$

$${rtt}_{dev} = \frac{( {α}_{quo} - {α}_{d} ) {rtt}_{dev} + {α}_{d} * ( {rtt}_{curr} - {rtt}_{meancurr} )}{{α}_{quo}}$$

$$rto = {rtt}_{meancurr} + 4 * {rtt}_{dev}$$

α_{quo}, αₛ and α_{d} are three coefficients for weighting the values used in the calculation. In one implementation, the values used are for example α_{quo}=256, αₛ=32 and α_{d}=64. The variable rtt_{meancurr} is a mean calculated at the present instant and the variable rtt_{meanprec} is a mean calculated at the previous iteration.

rtt_{curr} corresponds to the current value of the transit time. Its weighted mean value (rtt_{meancurr}) and the deviation between the current transit time and the mean transit time (rtt_{dev}) are calculated. It is considered that the values contained in a keepalive packet cannot be used to since the rtt_{cur} exceeds the value of rₜₒ, i.e. the difference thereof with respect to the mean is 4 times greater.

This mechanism makes it possible to avoid errors in calculating clock differences clockdiff under poor network conditions. The transmitter can thus effectively filter the unusable keepalive packets and obtain a more reliable measurement. Since the clock difference clockdiff can vary over time because of a possible clock drift between the transmitter and the receiver, it is important to make these exchanges and calculations regularly throughout the video transmission, for example every 50 ms.

FIG. 4 illustrates an example of architecture of a transmitter according to one embodiment. According to the example of hardware architecture shown in FIG. 4, the transmitter Em comprises, connected by a communication bus 401: a processor Proc 400; a random access memory RAM 403; a read only memory ROM 402; N network interfaces IF Res1 4041, IF Res2 4042 to IF ResN 404N enabling the transmitter to communicate with the receiver Re and an input interface 406 receiving the data stream to be transmitted.

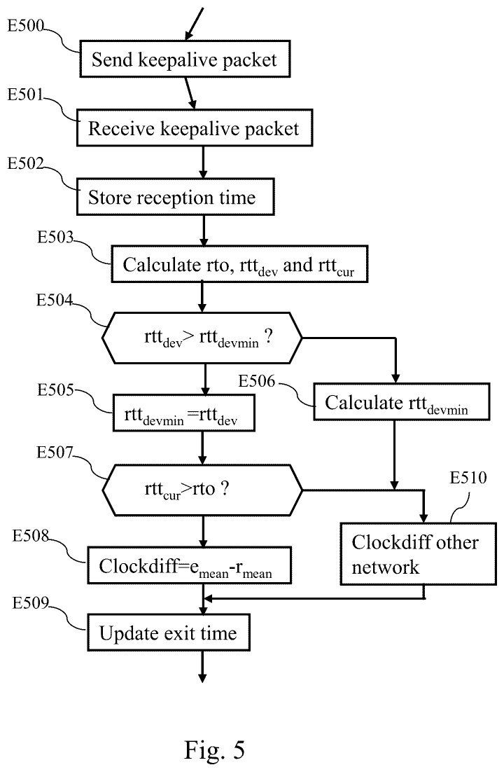

The processor 400 is capable of executing instructions loaded in the RAM 403 from the ROM 402, from an external memory (not shown), from a storage medium (such as an SD card), or from a communication network. When the transmitter Em is powered up, the processor 400 is capable of reading instructions from the RAM 403 and executing them. These instructions form a computer program causing the implementation, by the processor 400, of all or part of the method described in relation to FIG. 5.

The method described below in relation to FIG. 5 can be implemented in software form by executing a set of instructions by a programmable machine, such as a DSP (“digital signal processor”) or a microcontroller, or be implemented in hardware form by a machine or a dedicated component, for example an FPGA (field-programmable gate array) or an ASIC (application-specific integrated circuit). In general, the transmitter Em comprises electronic circuitry configured to implement the method described in relation to FIG. 5.

FIG. 5 illustrates an example of a method implemented by a transmitter according to one embodiment.

The present algorithm is executed periodically, for example with a periodicity of the order of one millisecond and for each communication network Res1, Res2 to ResN.

At the step E500, the transmitter Em demands the sending of a keepalive packet. The keepalive packet comprises a time marker eₑ that corresponds to the instant of sending of said packet.

At the step E501, the transmitter Em receives from the receiver Re a keepalive packet that comprises the two time markers eₑ and rᵣ and the time marker of the keepalive packet denoted rₑ received from the transmitter Em.

At the step E502, the transmitter Em stores its time of arrival(ₑᵣ).

At the step E503, the transmitter Em makes the following calculations:

$${e}_{mean} = ( {e}_{r} - {e}_{e} ) / 2$$

$${r}_{mean} = ( {r}_{r} - re ) / 2$$

$${rtt}_{curr} = ( {e}_{r} - {e}_{e} )$$

$${rtt}_{meancurr} = \frac{( {α}_{q u o} - {α}_{s} ) * {rtt}_{meanprec} + {α}_{s} * {rtt}_{curr}}{{α}_{q u o}}$$

$${rtt}_{dev} = \frac{( {α}_{q u o} - {α}_{d} ) {rtt}_{dev} + {α}_{d} * ( {rtt}_{curr} - {rtt}_{meancurr} )}{{α}_{quo}}$$

$$rto = {rtt}_{mean} + 4 * {rtt}_{dev}$$

At the step E504, the transmitter Em checks whether the value of rtt_{dev} calculated is greater than a value rtt_{devmin}.

If so, the transmitter Em passes to the step E506. If not, the transmitter Em passes to the step E505.

At the step E506, the transmitter calculates a new value of rtt_{devmin} in accordance with the following formula:

$${rtt}_{dev \_ min} = {rtt}_{dev \_ min} + min ( 10 \; 00 , {rtt}_{dev} * 0.02 )$$

In this way, the rtt_{dev_min} is increased by 2% of the current value of tt_{dev}, with a maximum of 1 ms. This increase makes it possible to calculate the local minimum of rtt_{dev} rather than its global minimum. In doing this, the increases in latencies caused by a change in network condition rather than by congestion are taken into account and do not cause a blockage of the system.

Once this operation has been performed, the transmitter Em interrupts the present algorithm when a single communication network is used or at the step E510 takes the value of the clockdiff calculated for another one of the communication networks when a plurality of communication networks are used.

At the step E505, the transmitter Em sets the value of rtt_{devmin} equal to rtt_{dev}.

At the following step E507, the transmitter Em checks whether the value of rtt_{cur} is greater than the value of rto. If so, the transmitter Em interrupts the present algorithm when a single communication network is used or at the step E510 takes the value of the clockdiff calculated for another one of the communication networks when a plurality of communication networks are used.

If not, the transmitter Em passes to the step E508 and calculates a new value of clockdiff in accordance with the following formula:

$$Clockdiff = {e}_{mean} - {r}_{mean}$$

At the step E510, the transmitter Em updates each time of exit of the packets with tₛ=tₑ+timewindow−clockdiff.

1. A method for updating a time at which at least one data packet is taken from an audiovisual stream transferred from a transmitter to a receiver by means of at least one communication network, wherein the method comprises the steps performed by the transmitter of:
transferring a first data packet comprising a first time marker corresponding to the instant of sending the first packet,
receiving a second data packet comprising the first time marker, a second time marker corresponding to the time of reception of the first packet and a third time marker corresponding to the instant of sending the second packet,
storing the time of reception of the second packet,
calculating, from the three time markers and from the time of reception of the second packet, a mean transit time,
calculating a weighted mean value and a deviation between the current transit time and the mean transit time, the weighted mean value and the deviation between the current transit time and the mean transit time are calculated from the following formulae:
rtt_{curr}=(eᵣ−eₑ) where eₑ is the first time marker and eᵣ is the time of reception of the second packet,
$${rtt}_{meancurr} = \frac{( {α}_{q u o} - {α}_{s} ) * {rtt}_{meanprec} + {α}_{s} * {rtt}_{curr}}{{α}_{q u o}}$$
$${rtt}_{dev} = \frac{( {α}_{quo} - {α}_{d} ) {rtt}_{dev} + {α}_{d} * ( {rtt}_{curr} - {rtt}_{m e a n curr} )}{{α}_{quo}}$$
where α_{quo}, αₛ and α_{d} are three coefficients for weighting the values used in the calculation, rtt_{meancurr} is the mean calculated at the present instant, the variable rtt_{meanprec} is the mean calculated at the previous iteration and rtt_{curr} corresponds to the current value of the transit time,
checking whether the mean transit time is above a predetermined threshold, the predetermined threshold being dependent on the weighted mean value and on the deviation between the current transit time and the mean transit time,
taking into account the mean transit time to update the time at which at least one data packet is taken from the audiovisual stream if at least the mean transit time is below or equal to the predetermined threshold,
not taking into account the mean transit time to update the time at which at least one data packet is taken from the audiovisual stream if the mean transit time is above the predetermined threshold.

2. The method according to claim 1, taking into account the mean transit time to update the time at which at least one data packet is taken from the audiovisual stream is furthermore dependent on a comparison of the deviation between the current transit time and the mean transit time with a minimum time.

3. The method according to claim 1, wherein the data packets of the audiovisual stream are transferred from the transmitter to the receiver by means of a plurality of communication networks and in that the method is implemented for each communication network.

4. The method according to claim 3, wherein the mean transit time is above the predetermined threshold, the time at which the at least one packet is taken is updated from the mean transit time of another communication network.

5. The method according to claim 2, wherein the communication networks are networks of the Ethernet, Wi-Fi, xDSL, KA-SAT, BGAN or cellular type.

6. A device for updating a time at which at least one data packet is taken from an audiovisual stream transferred from a transmitter to a receiver by means of at least one communication network, wherein the device is included in the transmitter and comprises electronic circuitry configured for:
transferring a first data packet comprising a first time marker corresponding to the instant of sending the first packet,
receiving a second data packet comprising the first time marker, a second time marker corresponding to the time of reception of the first packet and a third time marker corresponding to the instant of sending the second packet,
storing the time of reception of the second packet,
calculating, from the three time markers and from the time of reception of the second packet, a mean transit time,
calculating a weighted mean value and a deviation between the current transit time and the mean transit time, the weighted mean value and the deviation between the current transit time and the mean transit time are calculated from the following formulae:
rtt_{curr}=(eᵣ−eₑ) where eₑ is the first time marker and eᵣ is the time of reception of the second packet,
$${rtt}_{meancurr} = \frac{( {α}_{quo} - {α}_{s} ) * {rtt}_{meanprec} + {α}_{s} * {rtt}_{curr}}{{α}_{quo}}$$
$${rtt}_{dev} = \frac{( {α}_{quo} - {α}_{d} ) {rtt}_{dev} + {α}_{d} * ( {rtt}_{curr} - {rtt}_{meancurr} )}{{α}_{quo}}$$
where α_{quo}, αₛ and α_{d} are three coefficients for weighting the values used in the calculation, rtt_{meancurr} is the mean calculated at the present instant, the variable rtt_{meanprec} is the mean calculated at the previous iteration and rtt_{curr} corresponds to the current value of the transit time,
checking whether the mean transit time is above a predetermined threshold, the predetermined threshold being dependent on the weighted mean value and on the deviation between the current transit time and the mean transit time,
taking into account the mean transit time to update the time at which at least one data packet is taken from the audiovisual stream if at least the mean transit time is below or equal to the predetermined threshold,
not taking into account the mean transit time to update the time at which at least one data packet is taken from the audiovisual stream if the mean transit time is above the predetermined threshold.

7. (canceled)

8. A non-transitory storage medium, storing a computer program comprising instructions for implementing, by an item of equipment, the method according to claim 1, when said program is executed by a processor of a node.
